(19) United States
(12) Patent Application Publication
(10) Pub. No.: US 2004/0240813 A1
(43) Pub. Date: Dec. 2, 2004

(54) Pattern writing apparatus

(75) Inventor: Yasuyuki Koyagi, Kyoto (JP)

Correspondence Address: McDermott, Will & Emery, 600 13th Street, N.W., Washington, DC, 20005-3096, US

(73) Assignee: DAINIPPON SCREEN MFG. CO., LTD.

(21) Appl. No.: 10/815,824

(22) Filed: Apr. 2, 2004

(30) Foreign Application Priority Data
May 29, 2003 (JP) P2003-151835

(51) Int. Cl. G02B 6/26

(52) U.S. Cl. 385/115; 385/39

(57) ABSTRACT

A writing head (15) of a pattern writing apparatus has an LD board (20) having a plurality of semiconductor lasers, a fiber coupling part (21), optical fibers (22), an optical waveguide array (23) having a plurality of optical waveguides, mirrors (24, 28), optical units (25, 27, 29) and a polygon mirror (26). In the pattern writing apparatus, a large number of light beams generated in the LD board (20) are aligned by optical waveguide array (23) at a reduced pitch with high precision and deflected by the polygon mirror (26) for scanning a substrate (9). This achieves size reduction of the apparatus and allows high-speed writing of a high-definition pattern on a substrate (9).

### BACKGROUND OF THE INVENTION

1. Field of the Invention

The present invention relates to a technique for writing a pattern by irradiating a substrate with light.

2. Description of the Background Art

Conventionally, a technique for direct writing of a pattern by scanning a substrate with a plurality of light beams which are individually modulated has been used in a variety of fields. For example, Japanese Patent Application Laid Open Gazette No. 7-35994 (Patent document 1) discloses a technique in which a plurality of light beams which are obtained by dividing a laser beam and aligned are individually modulated and deflected by a polygon mirror for scanning, to reduce a time for beam direct-writing. Japanese Patent Application Laid Open Gazette No. 2002-169113 (Patent document 2) discloses a technique in which a plurality of light beams from an optical fiber array where fibers are arranged in two rows are used for scanning, to reduce a time for recording an image.

In a beam direct-writing apparatus disclosed in the Patent document 1, though the writing speed is increased by performing a scan with 16 light beams arranged in one row, further reduction of the writing time needs increase in the number of light beams, and in this case, since not only a light source part is upsized but also a polygon mirror, lenses and the like are upsized due to increase in width of the whole of light beams, manufacturing cost for the writing apparatus is increased.

In a beam direct-writing apparatus disclosed in the Patent document 2, though the writing speed is increased by performing a scan with light beams from an optical fiber array having two vertically-arranged rows each accommodating 32 optical fibers, further reduction of the writing time needs increase in the number of optical fibers. Since it is impossible, however, to set the pitch between light beams in each row smaller than the outer diameter of an optical fiber, like in the Patent Document 1, significant increase in the number of light beams inevitably causes upsizing of an optical system in the writing apparatus and increase of manufacturing cost for the writing apparatus.

As to an optical fiber, the center of its section and that of its core do not completely coincide with each other in some cases, and this causes a limitation of arrangement precision of light beams even if the optical fibers are arranged with high precision. There is a further problem of difficulty in controlling an outgoing direction of the light beams.

### SUMMARY OF THE INVENTION

The present invention is intended for a pattern writing apparatus for writing a pattern by irradiating an object with a plurality of modulated light beams. It is an object of the present invention to achieve high-speed writing of a high-definition pattern by performing scan with a large number of light beams which are arranged with high precision.

According to the present invention, the pattern writing apparatus comprises a light source part for generating a plurality of light beams which are modulated; an optical waveguide array having a plurality of input ends which are aligned and receive a plurality of light beams from the light source part, respectively, and a plurality of output ends which are aligned at a pitch smaller than the smallest one of intervals at which the plurality of input ends are aligned and output a plurality of light beams, respectively; a supporting part for supporting an object to be irradiated with a plurality of light beams from the optical waveguide array; and a scanning mechanism for scanning an object with a plurality of light beams from the optical waveguide array.

By using the optical waveguide array, it is possible to ensure size-reduction of the pattern writing apparatus and achieve high-speed writing of a high-definition pattern.

Preferably, a width of each of the plurality of output ends ranges from 5to 15 μm and the plurality of output ends are arranged at a pitch ranging from 10 to 20 μm.

According to an aspect of the present invention, the light source part comprises a plurality of semiconductor lasers, and it is thereby possible to ensure size-reduction of the light source part. Preferably, the plurality of semiconductor lasers are blue semiconductor lasers, and the optical waveguide array is mainly made of quartz. The optical waveguide array is formed by photolithography with high precision.

According to another aspect of the present invention, the pattern writing apparatus further comprises a plurality of optical fibers for leading a plurality of light beams from the light source part to the plurality of input ends, respectively. It is thereby possible to easily guide a plurality of light beams to the input ends of the optical waveguides. Preferably, in order to accurately guide a plurality of light beams to the input ends, a diameter of a core gradually decreases from an input end to an output end in each of the plurality of optical fibers.

According to a preferred embodiment, the scanning mechanism comprises a polygon mirror for collectively deflecting a plurality of light beams from the optical waveguide array. Since the light beams are arranged at a very small pitch, it is possible to ensure size-reduction of the polygon mirror.

According to still another aspect of the present invention, the pattern writing apparatus comprises an aperture plate having a plurality of apertures close to the plurality of output ends, respectively. It is thereby possible to improve uniformity in beam profile of the light beams.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a view showing a pattern writing apparatus in accordance with one preferred embodiment;

FIGS. 2 and 3 are a plan view and an elevational view, respectively, showing an internal construction of a writing head;

FIG. 4 is a view showing an LD board, a fiber coupling part, optical fibers and an optical waveguide array;

FIG. 5 is an enlarged view showing one optical fiber;

FIG. 6 is a view showing an end surface on an input side of the optical waveguide array;

FIG. 7 is a plan view showing a plurality of optical waveguides in the optical waveguide array;

FIG. 8 is a view showing an end surface on an output side of the optical waveguide array;

FIG. 9 is a view showing an aperture plate; and

FIG. 10 is a view showing beam spots on a substrate.

### DESCRIPTION OF THE PREFERRED EMBODIMENTS

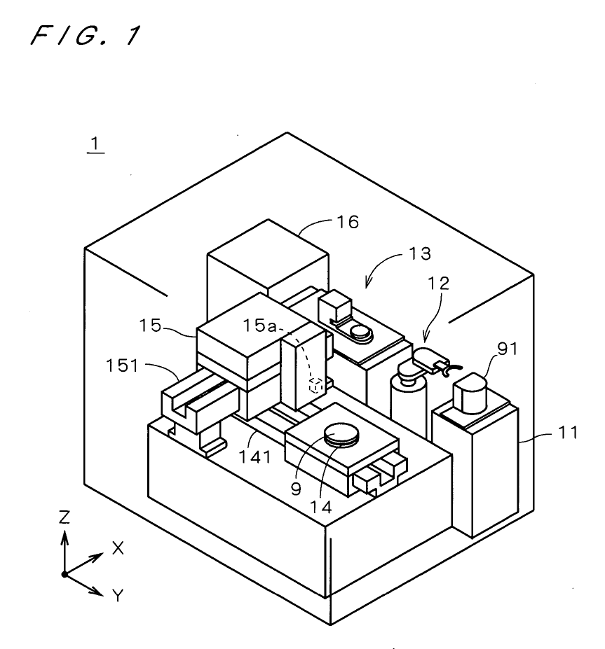

FIG. 1 is a perspective view showing a pattern writing apparatus 1 in accordance with one preferred embodiment of the present invention. The pattern writing apparatus 1 is an apparatus for writing a pattern on a resist film on a semiconductor substrate (hereinafter, referred to as a “substrate”) 9 by irradiating the substrate 9 with a plurality of modulated light beams and comprises a cassette mount 11 on which a cassette 91 for accommodating substrates 9 is mounted, a transfer robot 12 for taking a substrate 9 out from the cassette 91 and transferring it, a prealignment part 13 for performing a prealignment, a stage 14 for supporting the substrate 9 in writing and a writing head 15 for emitting a plurality of light beams to the substrate 9.

The stage 14 is moved by a stage moving mechanism 141 in the Y direction of FIG. I (which corresponds to a subscan direction of light beams) and the writing head 15 is moved by a head moving mechanism 151 in the X direction (which corresponds to a main scan direction of light beams). Operations of constituents in the pattern writing apparatus 1 are controlled by a control part in an electrical rack 16.

In writing a pattern, first, the cassette 91 is transferred into the pattern writing apparatus 1 and mounted on the cassette mount 11, and the substrate 9 is taken out from the cassette 91 and transferred to the prealignment part 13 by the transfer robot 12. In the prealignment part 13, a rough positioning of the substrate 9 is performed through prealignment, and then the substrate 9 is transferred onto the stage 14 by the transfer robot 12.

After that, alignment marks on the substrate 9 are sequentially positioned below the writing head 15 by the stage moving mechanism 141 and the head moving mechanism 151 and imaged by a camera 15a. Image data from the camera 15a is processed by an image processing circuit (not shown) in the electrical rack 16 and the positions of the alignment marks on the stage 14 are thereby obtained with precision. The stage 14 is provided with a rotation mechanism for slightly rotating the substrate 9 about an axis along the Z direction and after the alignment (positioning) is performed by the rotation mechanism so that the substrate 9 may turn to a direction suitable for writing, the substrate 9 is irradiated with light beams by the writing head 15.

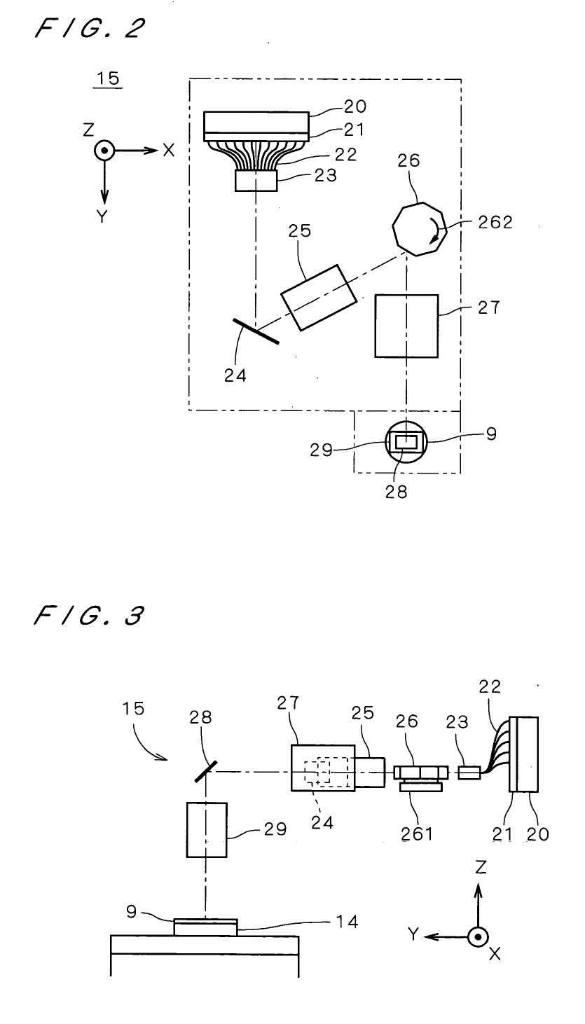

FIG. 2 is a plan view showing an internal construction of the writing head 15 and FIG. 3 is an elevational view showing the internal construction as viewed from the (+X) side toward the (−X) direction.

The writing head 15 comprises a board 20 having a plurality of semiconductor lasers (hereinafter, referred to as an “LD board”), a fiber coupling part 21, a large number of optical fibers 22, an optical waveguide array 23 in which a plurality of optical waveguides are arranged, mirrors 24 and 28, optical units 25, 27 and 29 and a polygon mirror 26. In figures referred to for the following discussion, for convenience of illustration, the number of optical fibers 22, optical waveguides or the like is less than actual number.

In the LD board 20 serving as a light source part, 500 blue semiconductor lasers for emitting light beams each having a wavelength of around 400 μm are densely arranged two-dimensionally in the X and Z directions of FIG. 2. The polygon mirror 26 is connected to a rotation axis which is orthogonally to an XY-plane of a motor 261 (see FIG. 3) and rotated in a direction indicated by an arrow 262 of FIG. 2.

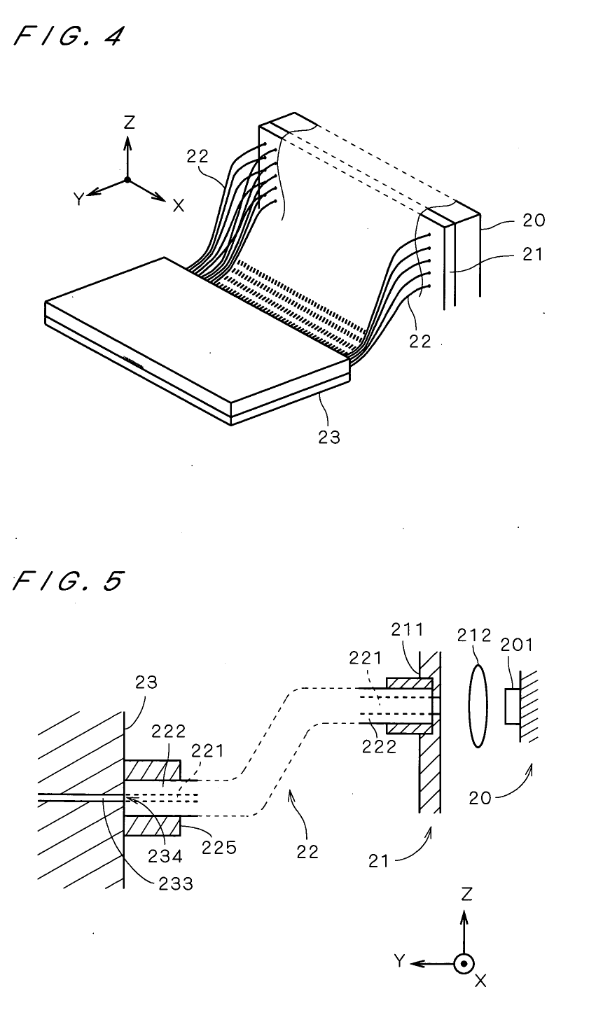

FIG. 4 is a perspective view showing the LD board 20, the fiber coupling part 21, the optical fibers 22 and the optical waveguide array 23. End portions of a plurality of optical fibers on a side of the LD board 20 are optically connected to a plurality of semiconductor lasers in the LD board 20, respectively, through the fiber coupling part 21, and end portions on the other side are connected to a plurality of optical waveguides in the optical waveguide array 23, respectively. In the writing head 15, by using the optical fibers 22, light from a plurality of semiconductor lasers can be easily led to the optical waveguide array 23.

In writing a pattern on the substrate 9, ON/OFF of a plurality of semiconductor lasers arranged in the LD board 20 are controlled to generate a plurality of light beams which are individually modulated and the light beams are inputted to a plurality of optical fibers 22, respectively. Hereinafter, in each optical fiber 22, the end surface to which a light beam is inputted is referred to as an “input end” and the other end surface is referred to as an “output end”.

FIG. 5 is an enlarged view showing one optical fiber 22. The optical fiber 22 has a construction in which a fiber core 221 whose diameter is gradually decreases from the input end toward the output end is covered with a clad 222. The input end is fixed to a fixed board 211 of the fiber coupling part 21, and a light beam from a semiconductor laser 201 in the LD board 20 is inputted to the end portion of the fiber core 221 through an aspherical lens 212. The output end is fixed to the optical waveguide array 23 with a bracket 225, and the fiber core 221 and an end surface 234 on an input side (hereinafter, referred to as an “input end”) of one optical waveguide 233 in the optical waveguide array 23 are thereby optically connected with accuracy.

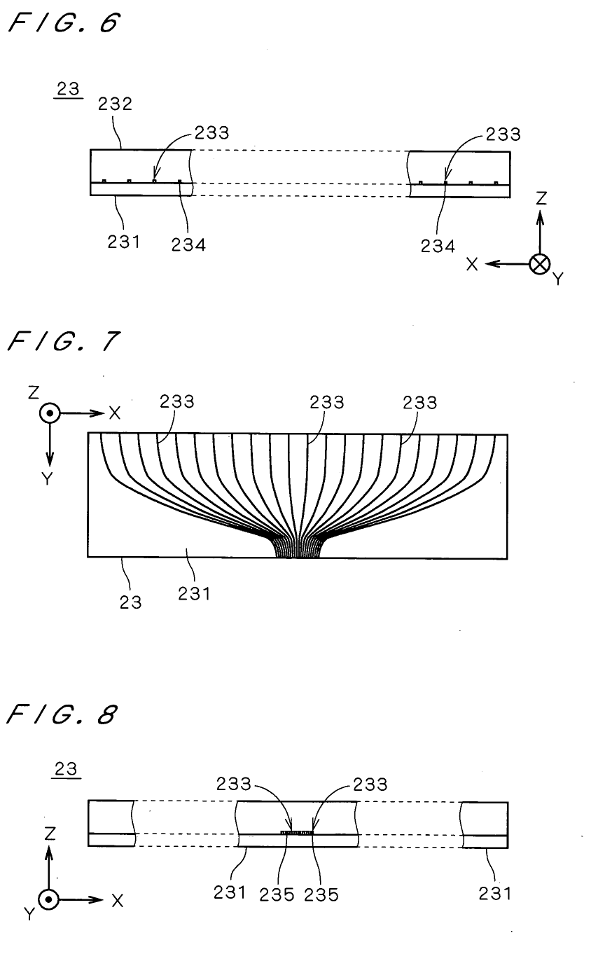

FIG. 6 is a view showing a surface on the input side of the optical waveguide array 23. The optical waveguide array 23 has a lower clad layer 231, an upper clad layer 232 and a plurality of optical waveguides (also referred to as “optical waveguide core”) 233. In forming the optical waveguide 233, an optical waveguide layer is formed on the lower clad layer 231 which is formed on silicon (Si) and the optical waveguides 233 are formed from the optical waveguide layer by photolithography with high precision. A plurality of input ends 234 are aligned at a regular pitch (distance between adjacent input ends 234). The optical waveguide 233 is mainly made of quartz having a characteristic of passing ultraviolet rays and can efficiently transmit a light beam of short wavelength from a blue semiconductor laser with low loss.

FIG. 7 is a plan view showing a plurality of optical waveguides 233 in the optical waveguide array 23. In FIG. 7, the (−Y) side is an input side from which the light beams are inputted to the optical waveguide array 23 and (+Y) side is an output side from which the light beams are outputted. The optical waveguide array 23 is a pitch change type one, where a plurality of optical waveguides 233 are so formed as to gradually become closer to one another from the input side toward the output side. A plurality of input ends 234 are aligned at a regular pitch and receive a plurality of light beams guided to the optical waveguide array 23 through the optical fibers 22 and the light beams are led to the output side through a plurality of optical waveguides 233, respectively.

FIG. 8 is a view showing an end surface on the output side of the optical waveguide array 23. End surfaces 235 on the output side (hereinafter, referred to as “output ends”) of a plurality of optical waveguides 233 are aligned on the lower clad layer 231 at a regular pitch smaller than that of the input ends 234. A plurality of light beams inputted to the optical waveguide array 23 are outputted from the optical waveguide array 23 as a plurality of light beams aligned at a pitch smaller than that for input.

In the present preferred embodiment, the number of optical fibers 22 and that of optical waveguides 233 are equal to the number (500) of semiconductor lasers 201, and the pitch between the input ends 234 in the optical waveguide array 23 is 125 μm so that an optical fiber and the corresponding input end 234 can be easily connected (e.g., fused) to each other and the distance between the input ends 234 on both ends is about 62 mm. The width of the output end 235 is several μm, the pitch between the output ends 235 is 10 μm, and the distance between the output ends 235 on both ends (in other words, the width in the whole of 500 light beams outputted from the optical waveguide array 23) is about 5 mm.

A plurality of light beams outputted from the output ends 235 of the optical waveguide array 23 are reflected on the mirror 24 in FIG. 2 and led to the polygon mirror 26 through control of the optical unit 25 having various lenses. Then, the light beams are collectively reflected on reflection surfaces of the rotating polygon mirror 26 to be deflected. The reflected light beams go through the optical unit 27 having various lenses and are

Pattern Writing Apparatus reflected on the mirror 28, going toward the (−Z) direction of FIG. 3, and emitted onto the substrate 9 through the optical unit 29 which is telecentric on the side of the substrate 9. The pitch of irradiation positions of the light beams on the substrate 9 (i.e., positions of beam spots) is 1I m through a minification optical system.

At that time, a plurality of light beams are collectively deflected by the polygon mirror 26 toward the substrate 9 for scanning in the main scan direction (X direction). At the same time, the substrate 9 is moved by the stage moving mechanism 141 with respect to the writing head 15 in the secondary scanning direction (Y direction), to perform writing of a pattern on the substrate 9. After that, the subscan is repeated required times, to perform beam direct-writing on the whole substrate 9.

As discussed above, in the pattern writing apparatus 1, since the pitch of a plurality of light beams is reduced by the optical waveguide array 23, even if a large number of light beams are inputted, the width in arrangement of the whole of light beams to be outputted can be reduced to a small size. It is thereby possible to ensure size-reduction (relative to the number of light beams) of constituents for emitting a plurality of light beams from the optical waveguide array 23 to the substrate 9 and scanning their irradiation positions with respect to the substrate 9 (i.e., the mirrors 24 and 28, the optical units 25, 27 and 29 and the polygon mirror 26), and therefore the pattern writing apparatus 1 can be downsized and the manufacturing cost can be lowered. In particular, with size-reduction of the polygon mirror 26 which is a large-scaled optical part, it is possible to ensure size-reduction of the writing head 15.

Additionally, with reduction in pitch of a plurality of light beams by the optical waveguide array 23, the reduction ratio of the minification optical system from the optical waveguide array 23 to the substrate 9 becomes small and therefore the optical units 25, 27 and 29 can be simplified in design.

Using a larger number of light beams at a time for scanning as compared with the conventional apparatus, the pattern writing apparatus 1 can achieve writing of a high-definition pattern at a high speed.

Since the writing head 15 in the pattern writing apparatus 1 uses semiconductor lasers as a light source, it is possible to ensure size-reduction of the light source part relative to the number of light beams. In particular, with two-dimensional arrangement of the semiconductor lasers, a significant size-reduction can be achieved as compared with a case of one-dimensional arrangement.

In each of the optical fibers 22 for guiding a large number of light beams which are emitted from the semiconductor lasers and modulated to the optical waveguide array 23, a light beam from the LD board 20 is easily inputted thereto as the fiber core 221 on the incident side has a relatively large diameter (e.g., 10 μm) and a light beam which is stable in a direction of center axis is outputted and inputted to the optical waveguide 233 with accuracy as the fiber core 221 on the outgoing side has a small diameter (e.g., 2 to 3 μm).

In the optical waveguide array 23, since the optical waveguides 233 are formed by photolithography with high precision, it is possible to correct variation of arrangement positions of the inputted light beams due to eccentricity of the fiber cores 221 (in other words, deviation of centers of the end surfaces of the fiber cores 221 from centers of the end surfaces of the optical fibers 22) and output a plurality of light beams aligned with high precision from the output ends 235. Further, by using the optical waveguides 233, it is possible to set the direction of center axes of the outputted light beams with high accuracy. It is also possible to uniformize beam profiles (i.e., light intensity distributions in sections of the beams) of the light beams to be outputted and light intensities and sectional shapes of a plurality of light beams. As a result, a large number of fine beam spots aligned with high precision can be scanned with respect to the substrate 9, and it is therefore possible to write a high-definition pattern at a high speed.

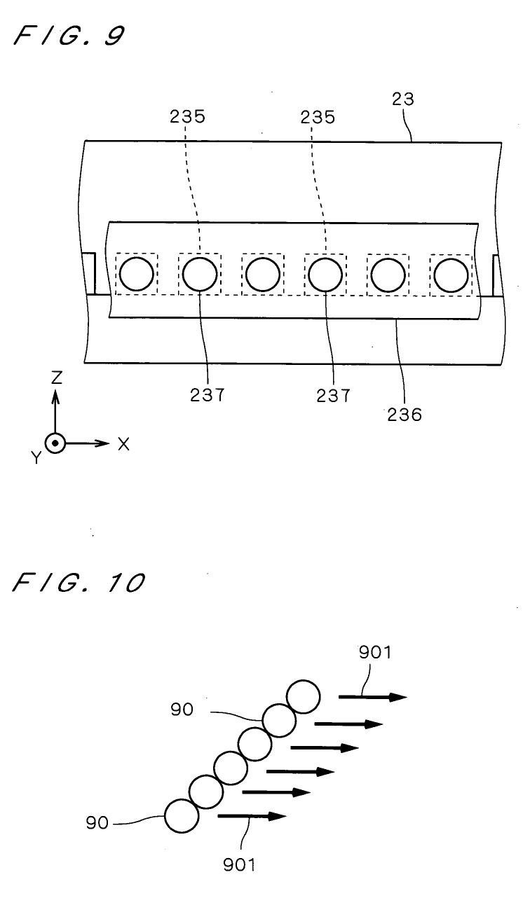

FIG. 9 is an enlarged view showing another exemplary output side of the optical waveguide array 23, where an aperture plate 236 is provided near the output side of the optical waveguide array 23. The aperture plate 236 has a plurality of round apertures 237 close to a plurality of output ends 235, respectively, and a plurality of apertures 237 are arranged at a regular pitch with high precision, correspondingly to a plurality of the output ends 235.

With the aperture plate 236, the uniformity in beam profiles of the light beams passing the apertures 237 is further improved and sections of the light beams to be emitted on the substrate 9 can be made circles of desired size. As a result, as shown in FIG. 10, a plurality of round beam spots 90 are formed on the substrate 9 in a linear arrangement, and through rotation of the polygon mirror 26 (see FIG. 2), a plurality of beam spots 90 are scanned in a direction indicated by an arrow 901 of FIG. 10 (i.e., in the main scan direction). It is thereby possible to easily improve precision of writing. The shape of aperture in the aperture plate 236 is not limited to a round shape but may be, for example, an ellipse or a rectangle in accordance with the characteristics of a photosensitive material such as a resist film.

Though the preferred embodiment of the present invention has been discussed above, the present invention is not limited to the above-discussed preferred embodiment, but allows various variations.

For example, the light source part is not necessarily limited to the LD board 20 in which a plurality of semiconductor lasers are arranged but may be a constituent in which a plurality of gas lasers, light emitting diodes or the like are arranged. A plurality of light beams may be generated by expanding one or more light beams from a light source part with a beam expander(s) and dividing it (them) with a beam splitter(s), and in this case, for example, modulation of the light beams is performed by acousto-optic modulators (AOMs).

In the optical waveguide array 23, the pitch of the input ends 234 do not necessarily have to be constant only if the pitch of the output ends 235 is constant. The object of the present invention, i.e., reduction of pitch, is achieved if the light beams are outputted from a plurality of output ends 235 aligned at a regular pitch which is smaller than the smallest interval of a plurality of input ends 234.

The optical waveguide 233 in the optical waveguide array 23 is not limited to one which is mainly made of quartz but may be one which is made of a polymer such as polyimide fluoride, a compound semiconductor or the like. In other words, various type ones may be used as an optical waveguide array 23 only if the light beams are inputted from the input ends 234, being transmitted, and outputted from the output ends 235 with a structure where optical waveguide cores having a high refractive index are covered with a clad layer having a low refractive index. The optical waveguides 233 should be preferably formed by photolithography in terms of precision and easiness of manufacture, but may be formed by other methods with high precision.

The scanning mechanism for scanning the substrate 9 with a plurality of light beams from the optical waveguide array 23 is not limited to the polygon mirror 26 but for example, a Galvanic mirror or an acousto-optic deflector (AOD) may be used.

Though 500 light beams are inputted to the optical waveguide array 23 and outputted at a pitch of 10 μm in the pattern writing apparatus 1, the number of light beams and the pitch may be changed as appropriate in accordance with the specification of the apparatus. If the characteristic feature that use of the optical waveguide array increases the density of the light beams is taken into consideration, it is preferable that 100 or more output ends 235 each having the width ranging from 5 to 15 μm are arranged at a pitch ranging from 10 to 20 μm in the optical waveguide array 23.

The substrate on which a pattern is written by the pattern writing apparatus 1 is not limited to a semiconductor substrate but may be a substrate on which a fine pattern is formed, such as a glass substrate used in a plasma display, a liquid crystal display, an organic EL display or a photomask, a printed circuit board or the like and further may be a substrate used for image recording, onto which a photosensitive material is applied (e.g., a printing plate).

While the invention has been shown and described in detail, the foregoing description is in all aspects illustrative and not restrictive. It is therefore understood that numerous modifications and variations can be devised without departing from the scope of the invention.

What is claimed is:

1. A pattern writing apparatus for writing a pattern by irradiating an object with a plurality of modulated light beams, comprising:
a light source part for generating a plurality of light beams which are modulated;
an optical waveguide array having a plurality of input ends which are aligned and receive a plurality of light beams from said light source part, respectively, and a plurality of output ends which are aligned at a pitch smaller than the smallest one of intervals at which said plurality of input ends are aligned and output a plurality of light beams, respectively;
a supporting part for supporting an object to be irradiated with a plurality of light beams from said optical waveguide array; and
a scanning mechanism for scanning an object with a plurality of light beams from said optical waveguide array.

2. The pattern writing apparatus according to claim 1, wherein said light source part comprises a plurality of semiconductor lasers.

3. The pattern writing apparatus according to claim 2, wherein said plurality of semiconductor lasers are blue semiconductor lasers.

4. The pattern writing apparatus according to claim 3, wherein said optical waveguide array is mainly made of quartz.

5. The pattern writing apparatus according to claim 1, wherein said optical waveguide array is formed by photolithography.

6. The pattern writing apparatus according to claim 1, further comprising
a plurality of optical fibers for leading a plurality of light beams from said light source part to said plurality of input ends, respectively.

7. The pattern writing apparatus according to claim 6, wherein
a diameter of a core gradually decreases from an input end to an output end in each of said plurality of optical fibers.

8. The pattern writing apparatus according to claim 1, wherein
said scanning mechanism comprises a polygon mirror for collectively deflecting a plurality of light beams from said optical waveguide array.

9. The pattern writing apparatus according to claim 1, further comprising
an aperture plate having a plurality of apertures close to said plurality of output ends, respectively.

10. The pattern writing apparatus according to claim 1, wherein
a width of each of said plurality of output ends ranges from 5 to 15 μm and said plurality of output ends are arranged at a pitch ranging from 10 to 20 μm.
